(19) United States
(12) Patent Application Publication
(10) Pub. No.: US 2018/0349451 A1
(43) Pub. Date: Dec. 6, 2018

(54) Presenting Related Points of Interest

(71) Applicant: Apple Inc., Cupertino, CA (US)

(72) Inventors: Alexander J. O'Connell, San Jose, CA (US); Aaron A. Reiner, Mountain View, CA (US); YunJae Kim, San Francisco, CA (US); Ryan D. Shelby, Mountain View, CA (US); Tianyi Zhou, San Jose, CA (US); Megan M. Frost, Menlo Park, CA (US); Brian J. Andrich, San Francisco, CA (US)

(73) Assignee: Apple Inc., Cupertino, CA (US)

(21) Appl. No.: 15/990,448

(22) Filed: May 25, 2018

Related U.S. Application Data
(60) Provisional application No. 62/514,490, filed on Jun. 2, 2017.

(51) Int. Cl. G06F 17/30

(52) U.S. Cl. CPC G06F 17/30554; G06F 17/30241; G06F 17/30601; G06F 17/3087; G06F 17/30867

(57) ABSTRACT

In some implementations, a computing device can present related points of interest in search results and/or on a map display. For example, the computing device can receive input specifying search parameters. The computing device can obtain search results, including points of interest, associated with the search parameters. The computing device can present the search results such that related points of interest are grouped and/or presented near each other. For example, if a point of interest (e.g., area of interest) corresponds to a geographical area, then the computing device can group the area of interest with other points of interest related to the area of interest. Similarly, when an area of interest is presented on a map display, the geographic area related to the area of interest can be highlighted and related points of interest can be represented on the map display.

### TECHNICAL FIELD

The disclosure generally relates to presenting map data.

### BACKGROUND

Computing devices have been used to search for locations, present map data describing locations, and present navigation instructions for travelling to a location. These locations may be referred to as points of interest. However, when reviewing search results, the user may have a difficult time determining how the various points of interest are related, or not related, to each other. Moreover, when the user does not know the name of a particular point of interest (POI), the user may perform a broad search for an area of interest (AOI) when the user is really interested in a particular point of interest that is in or related to the area of interest. It may be useful if search results and/or a map display were organized such that a user can quickly see how various points of interest are related to each other and/or related to a broader area of interest.

### SUMMARY

In some implementations, a computing device can present related points of interest in search results and/or on a map display. For example, the computing device can receive input specifying search parameters. The computing device can obtain search results, including points of interest, associated with the search parameters. The computing device can present the search results such that related points of interest are grouped and/or presented near each other. For example, if a point of interest (e.g., area of interest) corresponds to a geographical area, then the computing device can group the area of interest with other points of interest related to the area of interest. Similarly, when an area of interest is presented on a map display, the geographic area related to the area of interest can be highlighted and related points of interest can be represented on the map display. In some implementations, the user can provide input to filter the related points of interests based on various categories.

Particular implementations provide at least the following advantages. A user can quickly identify related points of interest within search results. The user can quickly identify related points of interest on a map display. The user can filter related points of interest based on class or category to quickly find points of interest that suit the user's needs.

Details of one or more implementations are set forth in the accompanying drawings and the description below. Other features, aspects, and potential advantages will be apparent from the description and drawings, and from the claims.

### DESCRIPTION OF DRAWINGS

FIG. 1 is a block diagram of an example system for presenting related points of interest.

FIG. 2 illustrates an example search graphical user interface presented by map application 104.

FIG. 3 illustrates an example map graphical user interface for presenting a selected area of interest.

FIG. 4 illustrates an example graphical user interface for presenting points of interest associated with a selected category.

FIG. 5 illustrates an example graphical user interface for presenting an individual point of interest.

FIG. 6 is flow diagram of an example process for presenting related points of interest in search results.

FIG. 7 is flow diagram of an example process for presenting related points of interest on a map display.

FIG. 8 is a block diagram of an example computing device that can implement the features and processes of FIGS. 1-7.

Like reference symbols in the various drawings indicate like elements.

### DETAILED DESCRIPTION

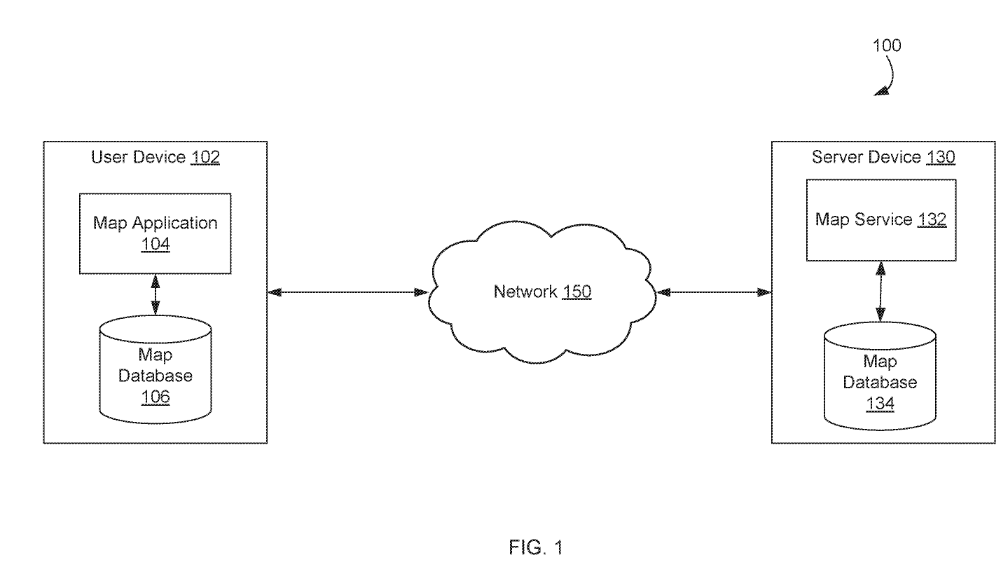

FIG. 1 is a block diagram of an example system 100 for presenting related points of interest. For example, system 100 can receive user input specifying search parameters for finding a location (e.g., point of interest). System 100 can find search results (e.g., points of interest) related to the search parameters and present the search results on a display such that related points of interest are grouped together. For example, points of interest related to (e.g., within or near) an area of interest can be presented grouped with the area of interest. For example, a point of interest that has a corresponding geographical area encompassing many locations or other points of interest can be referred to herein as an area of interest (e.g., a national park that includes multiple attractions or dining facilities can be an area of interest or a university that includes various university buildings, restaurants or sports facilities can be an area of interest). The user can select a point of interest to view a map graphical user interface that highlight a geographical area corresponding to the selected point of interest and/or points of interest related to the selected point of interest.

In some implementations, system 100 can include user device 102. For example, user device 102 can be a computing device, such as a laptop computer, smartphone, tablet computer, smart watch, in-car entertainment system, or other computing device.

In some implementations, user device 102 can include map application 104. For example, map application 104 can provide the maps features described herein, including point of interest search functionality and presentation of map graphical user interfaces (e.g., map displays) that present a representation of a geographic area as well as points of interest within or around the geographic area.

In some implementations, user device 102 can include map database 106. For example, when map application 104 receives map data, map application 104 can store the map data in map database 106. For example, when a user provides input to map application 104 specifying search parameters, map application 104 can send the search parameters to map service 132 on server device 130 through network 150 (e.g., the Internet). Map service 132 can search the map data in map database 134 to determine points of interest that correspond to the search parameters and return the determined points of interest to map application 104 on user device 102 through network 150. Map application 104 can then store the points of interest in map database 106 and present the points of interest as search results on a display of user device 102, as described further below.

When the user selects a point of interest (POI) (e.g., a point of interest or area of interest) from the displayed search results, map application 104 can request map data corresponding to the selected point of interest. The map data can include a graphical representation of the geographic area around the selected point of interest and/or points of interest related to the selected point of interest or area of interest, as described below. In response to receiving the request for map data corresponding to the selected point of interest, map service 132 can obtain the map data for the selected point of interest from map database 134.

In some implementations, in response to receiving the request for map data corresponding to the selected point of interest, map service 132 can obtain the map data for points of interest related to the selected point of interest from map database 134. For example, if the selected point of interest is an area of interest that has a corresponding geographic area (e.g., rather than a single location), map service 132 can determine points of interest that are within and/or within a threshold distance of the geographic area corresponding to the selected point of interest. Map service 132 can then send the map data, including data for the selected point of interest and related points of interest, to map application 104 for presentation on a display of user device 102.

In some implementations, a point of interest (or area of interest) can include various attributes (e.g., data) that define the point of interest. For example, the point of interest attributes can include coordinates (e.g., latitude, longitude, etc.) that define the location of the point of interest. The point of interest attributes can include an identifier (e.g., label, name, etc.) for the point of interest. When the point of interest is an area of interest, the point of interest attributes can include data defining the geographic area corresponding to the area of interest. The data defining the geographic area can correspond to borders, boundaries, property lines, or other data that defines the metes and bounds of the area of interest. The point of interest attributes can include a classification or category (e.g., restaurant, entrance, attraction, hotel, park, university, etc.) for the point of interest. The point of interest attributes can include a value or score that indicates how popular the point of interest is among users. When map application 104 receives map data, including points of interest and/or areas of interest, map application 104 can store the points of interest, including the point of interest attributes for each received point of interest, in map database 106.

In some implementations, system 100 can include server device 130. For example, server device 130 can represent a single computing device or group of computing devices that are accessible through network 150. Server device 130 can include map service 132 that provides or serves map data to map application 104. Map service 132 can provide a search interface that allows client applications (e.g., map application 104) running on client devices (e.g., user device 102) to search for map data (e.g., points of interest, areas of interest, maps, etc.) related to search parameters provided by the client applications. The map data can be stored in map database 134 on server device 130, for example, and map service 132 can search map database 134 to determine the appropriate map data for responding to a search request or a map request.

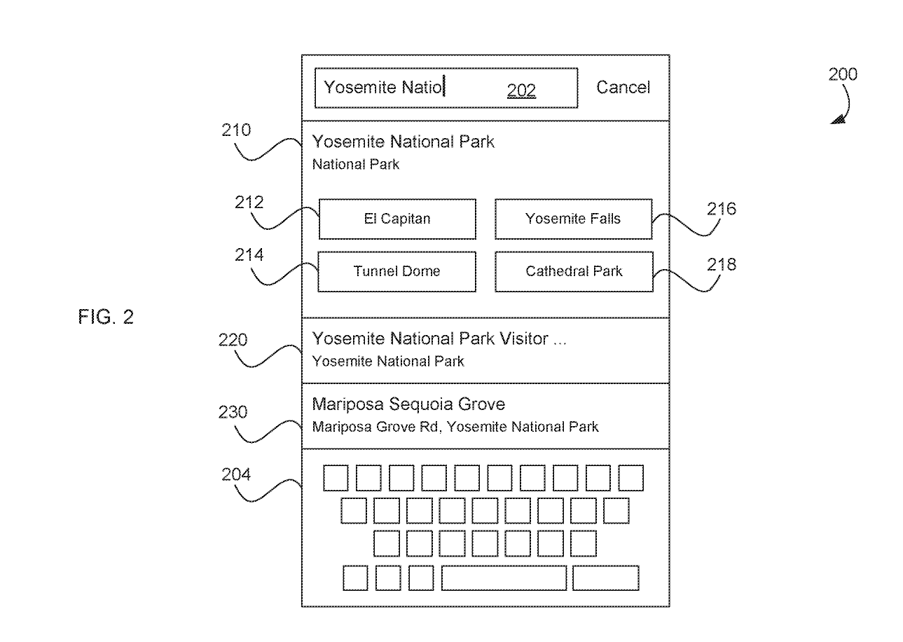

FIG. 2 illustrates an example search graphical user interface 200 presented by map application 104. For example, GUI 200 can be presented in response to a user invoking map application 104 and providing textual input to graphical element 202 (e.g., a text input box, a text control, etc.). As the user enters textual character input using virtual keyboard 204 or voice inputs, map application 104 can send the character input to map service 132 as a parameter to a search request or query. Map service 132 can search map database 134 for map data (e.g., points of interest, areas of interest, etc.) that corresponds to the character input. When map data corresponding to the character input is found in map database 134, map service 132 can send the corresponding map data to map application 104 as search results. Map application 104 can then present the search results (e.g., points of interest, areas of interest, etc.) on GUI 200.

In some implementations, GUI 200 can include graphical elements 210, 220, and/or 230 for presenting individual points of interest. For example, the search results (e.g., points of interest) generated by map service 132 can be ranked or ordered by map service 132 based on relevance to the received search parameters. Map application 104 can present each point of interest in respective graphical elements 210, 220 and/or 230 in the order specified by map service 132.

In some implementations, a point of interest can be grouped with other points of interest within a graphical element. For example, when a point of interest (e.g., an area of interest) identified in search results corresponds to a geographical area (e.g., a national park, an amusement park, university, etc.), the search results can identify related points of interest to present within the same graphical element as the area of interest. For example, graphical element 210 identifies “Yosemite National Park” as an area of interest that matches the search query “Yosemite Natio”. When map service 132 receives the search query and determines that the point of interest “Yosemite National Park” corresponds to a geographic area (e.g., an area of interest), map service 132 can determine or identify other (e.g. related) points of interest that are within and/or are within a threshold distance of the geographic area of Yosemite National Park. Map service 132 can then select a number (e.g., 4, 6, 3, etc.) of the other points of interest to associate with the Yosemite National Park point of interest in the map data. For example, map service 132 can receive information about the requesting client device's display size and determine a number of other or related points of interest to present with the area of interest based on the client device's display size. Map service 132 can determine the number of related points of interest to present with the area of interest based on the number of related points of interest found. For example, if an area of interest only has three related points of interest but the client device's screen size can accommodate six related points of interest, then map service 132 may determine that only three related points of interest will be presented by the client device. For example, map service 132 can link or otherwise indicate that the selected related points of interest should be presented with the Yosemite National Park point of interest in the search results (e.g., map data) returned to map application 104.

In some implementations, the other points of interest can be selected based on popularity. For example, if an area of interest has 12 related points of interest in and/or around the area of interest, map service 132 can select the most popular related points of interest to present with the area of interest in the search results presented on GUI 200. If GUI 200 is configured to only present four other or related points of interest with an area of interest, map service 132 can select the top four most popular points of interest to present with the area of interest within the search result graphical element (e.g., graphical element 210) corresponding to the area of interest.

When map application 104 receives the search results that indicate that an area of interest search result should include other related points of interest, map application 104 can present the other related points of interest grouped with the area of interest in the search results presented on GUI 200. For example, map application 104 can present the “Yosemite National Park” area of interest and graphical elements 212-218 that identify other points of interest related to Yosemite National Park together in graphical element 210. In some implementations, related points of interest that are grouped with an area of interest may not be presented as individual search result items. For example, a related point of interest that is presented with an area of interest may not be presented again in a separate search result graphical element on GUI 200.

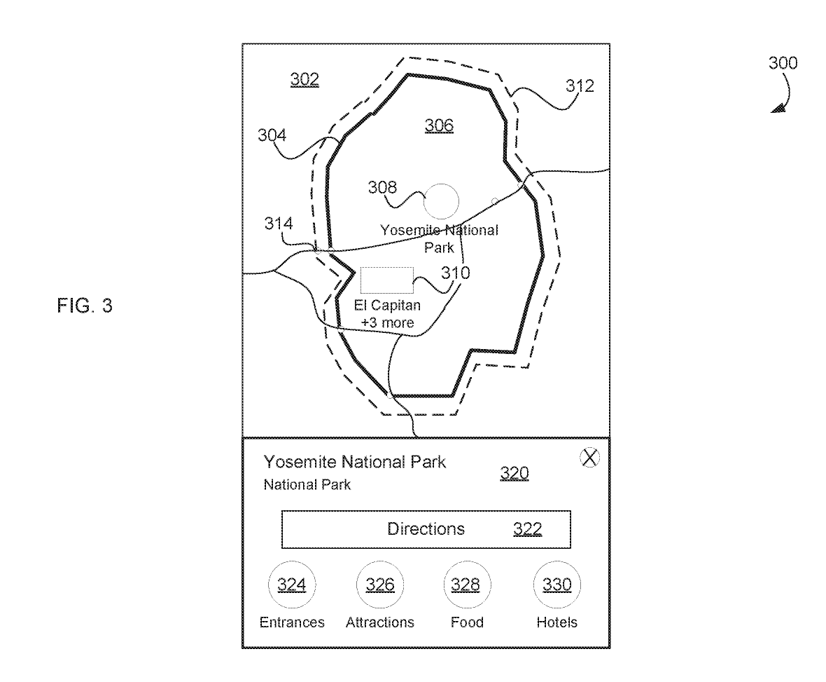

In some implementations, a user can select graphical element 210 to cause map application 104 to present a map corresponding to the area of interest presented by graphical element 210. For example, when map application 104 receives user input selecting graphical element 210, map application 104 can present GUI 300 of FIG. 3.

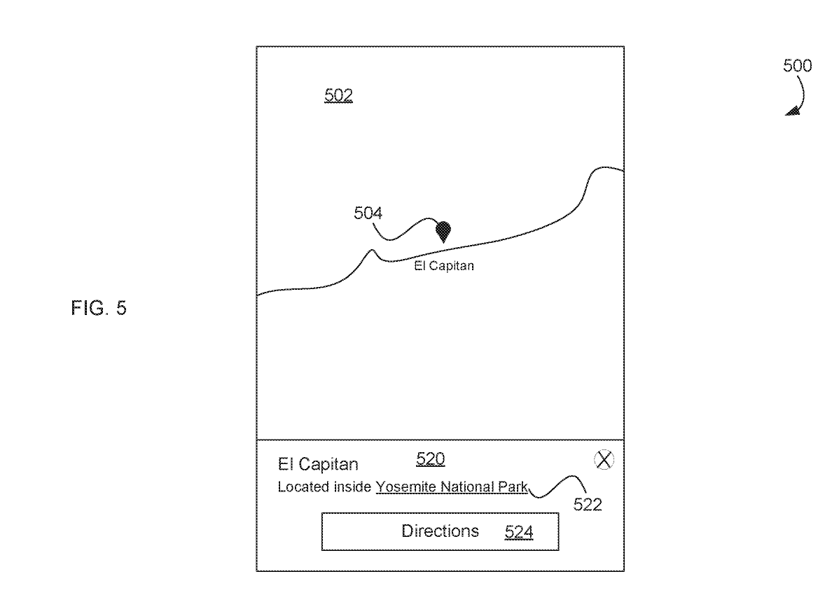

In some implementations, a user can select one of graphical elements 212-218 to cause map application 104 to present a map corresponding to the selected point of interest. For example, when map application 104 receives user input selecting graphical element 212, map application 104 can present graphical user interface 500 of FIG. 5.

FIG. 3 illustrates an example map graphical user interface 300 for presenting a selected area of interest. For example, GUI 300 can be presented by map application 104 on a display of user device 102 in response receiving user input selecting graphical element 210 of FIG. 2. When map application 104 receives user input selecting graphical element 210, map application 104 can send a map query to map service 132 that identifies the selected point of interest or area of interest (e.g., “Yosemite National Park”). Map service 132 can then generate map data for presenting the Yosemite National Park area of interest and return the map data to map application 104 for presentation on GUI 300. The map data can include a map of the area surrounding the selected area of interest and points of interest within the boundary and/or within a threshold distance of the boundary defined for the selected area of interest.

In some implementations, GUI 300 can include map display 302. For example, when map application 104 receives map data for a selected area of interest (e.g., point of interest), the map data can include a geographic location (e.g., latitude, longitude) for the area of interest, information defining a geographic area for the area of interest, and a map of the geographic area including and surrounding the area of interest. Map application 104 can then present the map in map display 302, along with an identifier 308 for the selected area of interest, and an outline (e.g., line 304) of the geographic area corresponding to the area of interest. For example, identifier 308 can include an image representing or depicting the area of interest. Identifier 308 can include an image representing the point of interest category of classification associated with the area of interest. In some implementations, line 304 can be drawn in a way to highlight the selected area of interest. Line 304 can be thicker than other lines on map display 302 or drawn in a distinct color from other lines on map display 302, for example. In some implementations, map application 104 can shade the interior 306 of the selected area of interest to highlight the portion of the map corresponding to the selected area of interest.

In some implementations, map display 302 can include points of interest (e.g., point of interest 310, point of interest 314, etc.) related to the selected area of interest. For example, the map data received by map application 104 may include popular points of interest within or nearby the selected area of interest. Popular points of interest can be those that users frequently search for or frequently select when performing searches. Points of interest can be determined to be nearby the selected area of interest when the points of interest are within a threshold distance (e.g., 1 mile, 2 miles, etc.) of the perimeter of the area of interest, as represented by dashed line 312. The most popular points of interest (e.g., the top 3, top 4, etc.) can be presented with graphics representing or depicting the points of interest. The less popular points of interest can be represented by a graphical element (e.g., empty circles on map display 302) so that the user can see that other points of interest exist within the geographic area represented by map display 302. In some implementations, the graphical elements representing the points of interest can include an image of the point of interest. For example, the graphic representing the point of interest “El Capitan” can include an image or photograph of the mountain “El Capitan.” The graphical elements representing the points of interest can be colored to indicate the point of interest category corresponding to the respective points of interest. For example, each point of interest category can have a corresponding color that is different than other point of interest categories. Thus, when presenting graphical elements representing points of interest and/or point of interest categories, the graphical elements can be colored according to the category of the corresponding point of interest and/or point of interest category. The graphical elements representing points of interest can include images representing or indicating the point of interest category corresponding to the respective points of interest. For example, the “food” category can be represented by an image of a fork and knife, while the “stores” category can be represented by an image of a shopping bag.

In some implementations, several points of interest may be grouped into a single point of interest representation. For example, point of interest 310 actually represents four different points of interest, as indicated by the text “+3 more”. Points of interest can be grouped when the locations of the points of interest are so close that the points of interest cannot be displayed individually at the current zoom level of map display 302. A user can select the grouped point of interest 310 to cause map display 302 to zoom in on the area corresponding to the grouped point of interest 310. Once zoomed in, map display 302 can present each of the points of interest in the grouped point of interest 310 individually on map display 302.

In some implementations, GUI 300 can include placard 320 for presenting additional information and/or options for exploring the selected area of interest. For example, placard 320 can be a scrollable or moveable overlay or sheet that presents additional information about the selected area of interest. For example, placard 320 can include an identifier (e.g., Yosemite National Park) for the selected area of interest and/or a classification or category for the selected area of interest (e.g., National Park). Placard 320 can include a selectable graphical element 322 for requesting navigation instructions for how to travel to the selected area of interest. For example, the user can select graphical element 322 to cause map application 104 to obtain navigation instructions from map service 132 and present the navigation instructions on a graphical user interface of map application 104.

In some implementations, placard 320 can include graphical elements 324, 326, 328 and/or 330 for causing map application 104 to present points of interest related to the selected area of interest. For example, each graphical element 324, 326, 328 and/or 330 can correspond to a point of interest category or classification. The categories can include entrances, attractions, food, hotels, museums, landmarks, activities, schools, sights, stores, or any other category. The categories represented by graphical elements 324, 326, 328 and/or 330 can be configured based on the categories represented by the points of interest related to the selected area of interest. For example, when the selected area of interest is a park, the point of interest categories can include entrances, attractions, food, hotels, activities, landmarks, museums, etc. When the selected area of interest is a university (e.g., university or college campus), the point of interest categories can include schools, sights, food, stores, athletic facilities, etc. Thus, the categories represented by graphical elements 324, 326, 328 and/or 330 for two different areas of interest may be different.

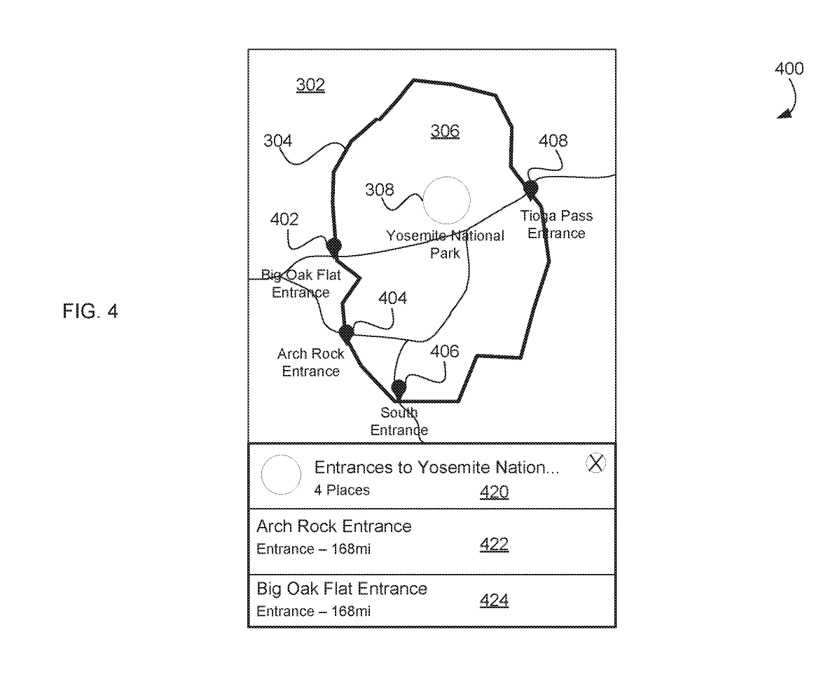

In some implementations, graphical elements 324, 326, 328 and/or 330 can include graphical elements representing their respective point of interest categories. The graphical elements representing the points of interest categories can be colored to indicate the point of interest category. For example, each point of interest category can have a corresponding color that is different than other point of interest categories. The “school” category can be represented by the color brown, while the “food” category can be represented by the color orange, for example. Thus, when presenting graphical elements representing point of interest categories, graphical elements 324, 326, 328 and/or 330 can be colored according to the point of interest category that they represent. The graphical elements representing points of interest categories can include images representing or indicating the point of interest category corresponding to the respective points of interest. For example, the “food” category can be represented by an image of a fork and knife, while the “stores” category can be represented by an image of a shopping bag. A user can select one of graphical elements 324, 326, 328 and/or 330 to cause map application 104 to present a graphical user interface that shows points of interest related to the selected area of interest and that are within the selected category, as illustrated by FIG. 4.

FIG. 4 illustrates an example graphical user interface 400 for presenting points of interest associated with a selected category. For example, GUI 400 can be presented by map application 104 in response to the user selecting graphical element 324 on GUI 300. While GUI 400 presents points of interest within a specific category (e.g., “Entrances”), the features described with respect to GUI 400 can be used to present points of interest associated with other point of interest categories, as described above. For example, a user can select graphical element 238 to cause map application 104 to present points of interest within the “Food” category (e.g., restaurants, grocery stores, etc.) on a graphical user interface similar to GUI 400.

In some implementations, GUI 400 can present points of interest that are associated with a selected category. For example, instead of selecting related points of interest to present based on popularity, map application 104 can filter the related points of based on the category selected by the user and present the most popular points of interest in the selected category. Thus, when the user selects graphical element 324 corresponding to the “Entrances” category, map application 104 can present the most popular entrances (e.g., points of interest 402, 404, 406, 408) to the selected area of interest (e.g., Yosemite National Park) on map display 302. When the user selects a category, related points of interest that are not associated with the category may not be presented on map display 302. However, the selected area of interest may still be identified on map display 302.

In some implementations, GUI 400 can include placard 420. For example, placard 420 can be a scrollable or moveable overlay or sheet that presents additional information about the selected point of interest category. For example, placard 420 can identify the selected point of interest category. Continuing the example above, when the user selects the “Entrances” category, placard 420 can identify the selected category at the top of placard 420. Placard 420 can also include identifiers for the individual points of interest within the selected category. For example, placard 420 can include selectable graphical elements 422, and/or 424 that identify the points of interest within the selected category. The user can select graphical element 422 or 424 to cause map application 104 to present a graphical user interface that shows the selected point of interest on a map display, as illustrated by FIG. 5.

In some implementations, the graphical elements representing the points of interest for a selected category can include an image of the point of interest. For example, the graphic representing the point of interest “El Capitan” can include an image or photograph of the mountain “El Capitan.” The graphical elements representing the points of interest can be colored to indicate the point of interest category corresponding to the respective points of interest. For example, each point of interest category can have a corresponding color that is different than other point of interest categories. Thus, when presenting graphical elements representing points of interest and/or point of interest categories, the graphical elements can be colored according to the category of the corresponding point of interest and/or point of interest category. For example, when the “Entrances” category is selected and the “Entrances” category is represented by the color brown, graphical elements 402, 404, 406, and/or 408 can be colored brown so that the user can quickly and easily identify the corresponding points of interest as entrances. The graphical elements representing points of interest can include images representing or indicating the point of interest category corresponding to the respective points of interest. For example, the “food” category can be represented by an image of a fork and knife, while the “stores” category can be represented by an image of a shopping bag.

FIG. 5 illustrates an example graphical user interface 500 for presenting an individual point of interest. For example, GUI 500 can be presented by map application 104 in response to the user selecting a point of interest from the search results presented on GUI 200. GUI 500 can be presented in response to the user selecting graphical element 212, for example. Alternatively, GUI 500 can be presented by map application 104 in response to the user selecting a point of interest presented on placard 420 of GUI 400.

In some implementations, GUI 500 can include map display 502. For example, map display 502 can present a map of the geographic area surrounding the selected point of interest. For example, when the user selects the “El Capitan” point of interest from GUI 200 or GUI 400 (e.g., when the “Attractions” category is selected), map application 104 can present the geographic area surrounding “El Capitan” on map display 502 and a graphical representation 504 of the selected point of interest.

In some implementations, GUI 500 can include placard 520. For example, placard 520 can be a scrollable or moveable overlay or sheet that presents additional information about the selected point of interest. In this case, placard 520 can identify the selected point of interest (e.g., El Capitan) and indicate that the selected point of interest is located inside an area of interest (e.g., Yosemite National Park). When the selected point of interest is related to an area of interest, placard 520 can include a selectable graphical element 522 that a user can select to cause map application 104 to present the area of interest on a graphical user interface of map application 104, as described above with respect to FIG. 3. Placard 520 can include a selectable graphical element 524 for causing map application 104 to obtain and present navigation instructions for travelling to the selected point of interest.

### Example Processes

To enable the reader to obtain a clear understanding of the technological concepts described herein, the following processes describe specific steps performed in a specific order. However, one or more of the steps of a particular process may be rearranged and/or omitted while remaining within the contemplated scope of the technology disclosed herein. Moreover, different processes, and/or steps thereof, may be combined, recombined, rearranged, omitted, and/or executed in parallel to create different process flows that are also within the contemplated scope of the technology disclosed herein. Additionally, while the processes below may omit or briefly summarize some of the details of the technologies disclosed herein for clarity, the details described in the paragraphs above may be combined with the process steps described below to get a more complete and comprehensive understanding of these processes and the technologies disclosed herein.

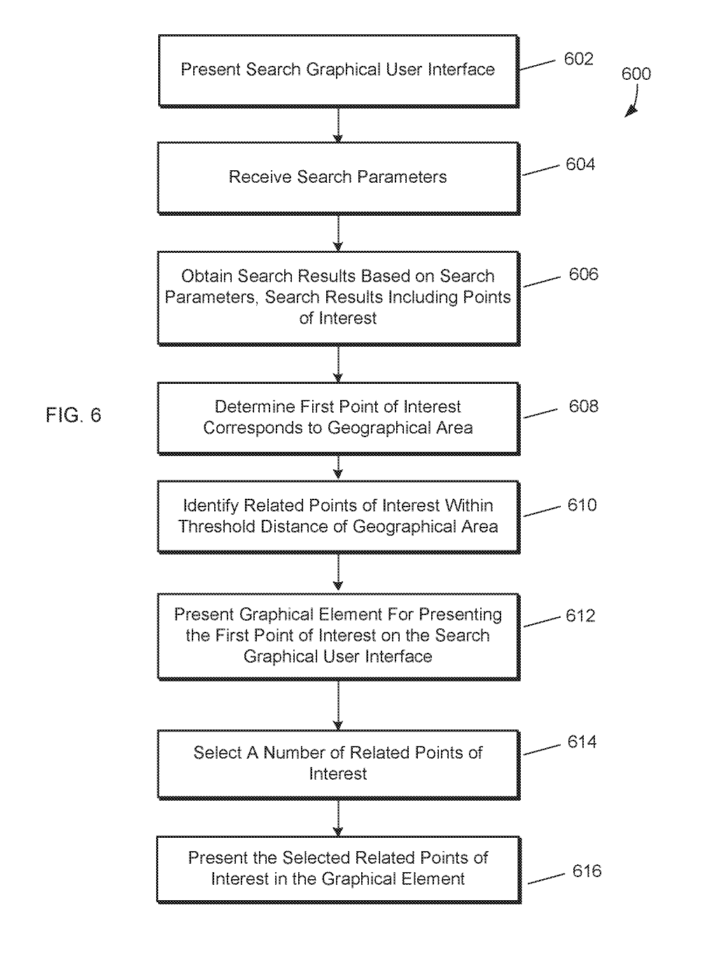

FIG. 6 is flow diagram of an example process 600 for presenting related points of interest in search results. For example, process 600 can be performed by user device 102 to present related points of interest in search results.

At step 602, user device 102 can present a search graphical user interface. For example, map application 104 can present the search interface when map application 104 is invoked by a user on user device 102, as described above with reference to FIG. 2.

At step 604, user device 102 can receive search parameters. For example, map application 104 can receive textual input from a user specifying parameters for searching for points of interest and/or areas of interest, as described above with reference to FIG. 2.

At step 606, user device 102 can obtain search results based on search parameters. For example, when map application 104 receives the search parameters (e.g., text string), map application 104 can send a search request to map service 132 that includes the search parameters. Map service 132 can then find points of interest and/or areas of interest that correspond to the search parameters. When an area of interest is found, map service 132 can find or determine points of interest related to the area of interest, as described above. Map service 132 can then send the points of interest, areas of interest, and/or related points of interest associated with the search parameters as search results to map application 104.

At step 608, user device 102 can determine that first point of interest corresponds to geographical area. For example, map application 104 can determine that the first point of interest (e.g., area of interest) includes data defining a geographical area covered by the first point of interest.

At step 610, user device 102 can identify related points of interest within a threshold distance of the geographical area corresponding to the first point of interest. For example, map application 104 can identify points of interest that are within one mile of the border of the geographical area corresponding to the first point of interest. Map application 104 can identify points of interest that are within the geographical area corresponding to the first point of interest. These other points of interest can be considered related points of interest in that they are geographically related to the first point of interest.

At step 612, user device 102 can present a graphical element for presenting the first point of interest. For example, map application 104 can present graphical element 210 of FIG. 2 that includes a description of the first point of interest.

At step 614, user device 102 can select a number of related points of interest. For example, map application 104 can select four of the most popular points of interest related to the first point of interest (e.g., area of interest).

At step 616, user device 102 can present the selected related points of interest in the graphical element. For example, map application 104 can present the selected related points of interest in the graphical element along with the description of the first point of interest. Thus, the related points of interest can be presented proximate to or grouped with the first point of interest (area of interest) so that the user can easily determine which points of interest are related to the first point of interest, as described above with reference to FIG. 2.

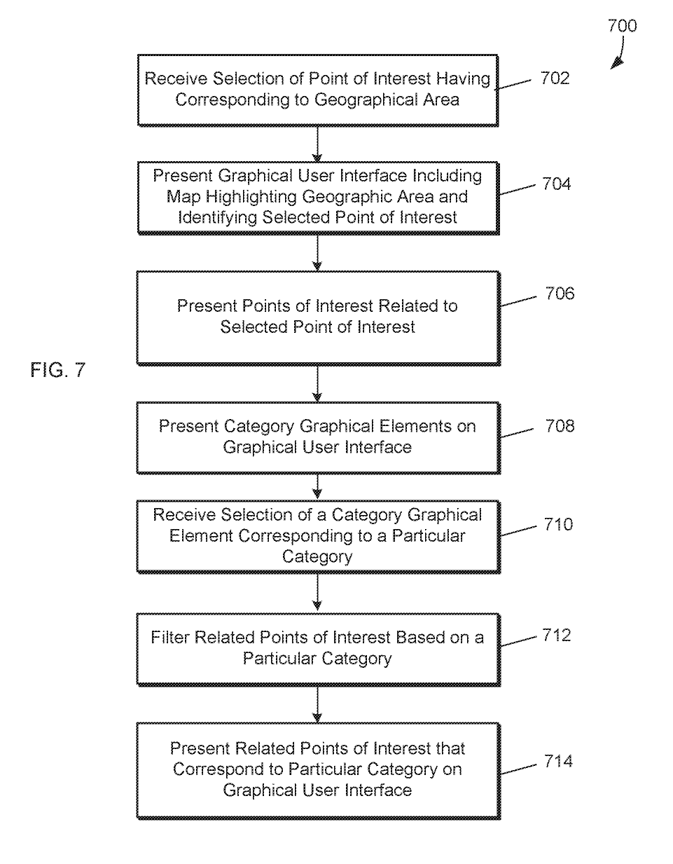

FIG. 7 is flow diagram of an example process 700 for presenting related points of interest on a map display. For example, process 700 can be performed by user device 102 to present an area of interest and/or related points of interest on a map display in response to a user selecting a point of interest or area of interest from the search results presented in GUI 200 of FIG. 2.

At step 702, user device 102 can receive user input selecting a point of interest having a corresponding to a geographical area. For example, map application 104 can receive user input selecting an area of interest from a listing of search results presented on GUI 200 of FIG. 2.

At step 704, user device 102 can present a graphical user interface including a map display highlighting the geographic area and identifying the selected point of interest. For example, map application 104 can determine a geographic area encompassed by the selected area of interest and highlight the geographic area by circumscribing the geographic area with a distinctive line. In some implementations, map application 104 can further highlight the geographic area by shading the geographic area with a distinct color and/or pattern. Map application 104 can apply a label to the geographic area that identifies the selected area of interest.

At step 706, user device 102 can present points of interest related to the selected point of interest on the map display. For example, in addition to highlighting the geographic area corresponding to the selected area of interest, map application 104 can present graphical elements (e.g., markers, text, images, etc.) representing point of interest related to the selected area of interest, as described above with respect to FIG. 3. When related points of interest are too close together to be presented individually, map application 104 can group the points of interest and represent the grouped points of interest on the map using a single graphical element.

At step 708, user device 102 can present point of interest category graphical elements on the graphical user interface. For example, map application 104 can present one or more graphical elements each one corresponding to a point of interest category. The point of interest categories presented by map application 104 can be selected from the categories associated with the points of interest related to the selected area of interest presented on the graphical user interface.

At step 710, user device 102 can receive a selection of a category graphical element corresponding to a particular point of interest category. For example, map application 104 can receive user input selecting a category graphical element corresponding to “entrances,” or “food,” or “attractions,” or “lodging.”

At step 712, user device 102 can filter the points of interest related to the selected point of interest based on the particular category selected by the user. For example, map application 104 can select related points of interest that correspond to the selected area of interest and also correspond to the selected category for presentation on the graphical user interface.

At step 714, user device 102 can present the related points of interest that correspond to the particular category on the graphical user interface. For example, map application 104 can present the related points of interest that correspond to the selected category on a map display, as described above with reference to GUI 400 of FIG. 4. Map application 104 can present the related points of interest that correspond to the selected category on a placard on the same graphical user interface as the map display, as described above with reference to GUI 400 of FIG. 4.

### Graphical User Interfaces

This disclosure above describes various Graphical User Interfaces (GUIs) for implementing various features, processes or workflows. These GUIs can be presented on a variety of electronic devices including but not limited to laptop computers, desktop computers, computer terminals, television systems, tablet computers, e-book readers and smart phones. One or more of these electronic devices can include a touch-sensitive surface. The touch-sensitive surface can process multiple simultaneous points of input, including processing data related to the pressure, degree or position of each point of input. Such processing can facilitate gestures with multiple fingers, including pinching and swiping.

When the disclosure refers to “select” or “selecting” user interface elements in a GUI, these terms are understood to include clicking or “hovering” with a mouse or other input device over a user interface element, or touching, tapping or gesturing with one or more fingers or stylus on a user interface element. User interface elements can be virtual buttons, menus, selectors, switches, sliders, scrubbers, knobs, thumbnails, links, icons, radio buttons, checkboxes and any other mechanism for receiving input from, or providing feedback to a user.

### Privacy

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for targeted content delivery services. In yet another example, users can select to not provide precise location information, but permit the transfer of location zone information.

### Example System Architecture

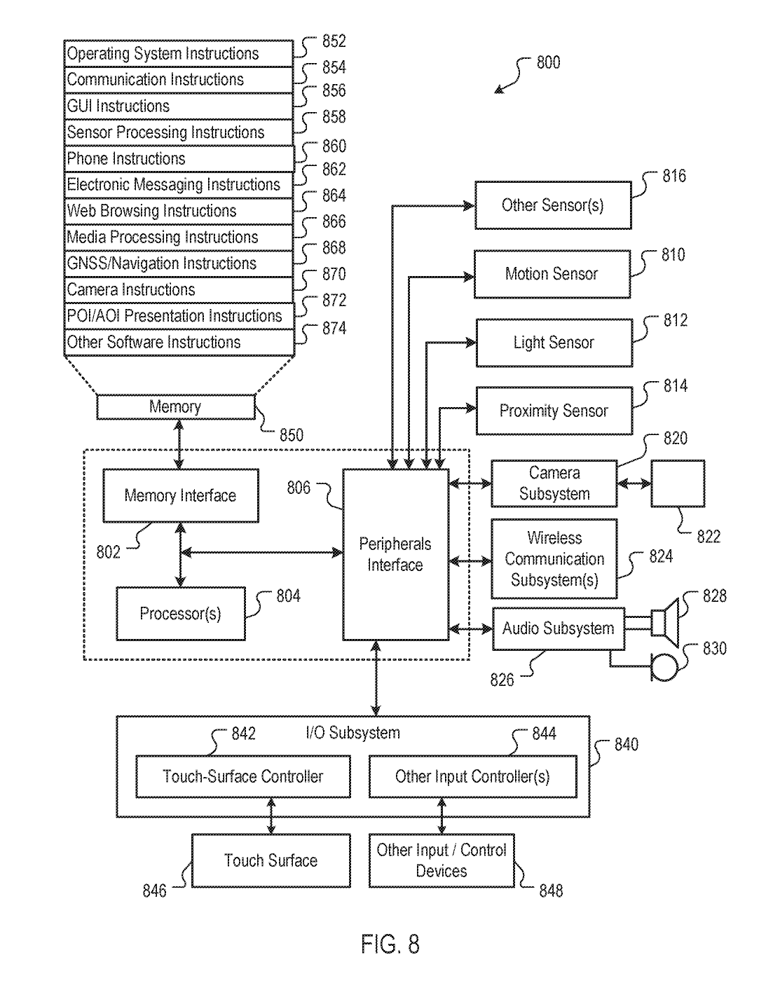

FIG. 8 is a block diagram of an example computing device 800 that can implement the features and processes of FIGS. 1-7. The computing device 800 can include a memory interface 802, one or more data processors, image processors and/or central processing units 804, and a peripherals interface 806. The memory interface 802, the one or more processors 804 and/or the peripherals interface 806 can be separate components or can be integrated in one or more integrated circuits. The various components in the computing device 800 can be coupled by one or more communication buses or signal lines.

Sensors, devices, and subsystems can be coupled to the peripherals interface 806 to facilitate multiple functionalities. For example, a motion sensor 810, a light sensor 812, and a proximity sensor 814 can be coupled to the peripherals interface 806 to facilitate orientation, lighting, and proximity functions. Other sensors 816 can also be connected to the peripherals interface 806, such as a global navigation satellite system (GNSS) (e.g., GPS receiver), a temperature sensor, a biometric sensor, magnetometer or other sensing device, to facilitate related functionalities.

A camera subsystem 820 and an optical sensor 822, e.g., a charged coupled device (CCD) or a complementary metal-oxide semiconductor (CMOS) optical sensor, can be utilized to facilitate camera functions, such as recording photographs and video clips. The camera subsystem 820 and the optical sensor 822 can be used to collect images of a user to be used during authentication of a user, e.g., by performing facial recognition analysis.

Communication functions can be facilitated through one or more wireless communication subsystems 824, which can include radio frequency receivers and transmitters and/or optical (e.g., infrared) receivers and transmitters. The specific design and implementation of the communication subsystem 824 can depend on the communication network(s) over which the computing device 800 is intended to operate. For example, the computing device 800 can include communication subsystems 824 designed to operate over a GSM network, a GPRS network, an EDGE network, a Wi-Fi or WiMax network, and a Bluetooth™ network. In particular, the wireless communication subsystems 824 can include hosting protocols such that the device 100 can be configured as a base station for other wireless devices.

An audio subsystem 826 can be coupled to a speaker 828 and a microphone 830 to facilitate voice-enabled functions, such as speaker recognition, voice replication, digital recording, and telephony functions. The audio subsystem 826 can be configured to facilitate processing voice commands, voiceprinting and voice authentication, for example.

The I/O subsystem 840 can include a touch-surface controller 842 and/or other input controller(s) 844. The touch-surface controller 842 can be coupled to a touch surface 846. The touch surface 846 and touch-surface controller 842 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 846.

The other input controller(s) 844 can be coupled to other input/control devices 848, such as one or more buttons, rocker switches, thumb-wheel, infrared port, USB port, and/or a pointer device such as a stylus. The one or more buttons (not shown) can include an up/down button for volume control of the speaker 828 and/or the microphone 830.

In one implementation, a pressing of the button for a first duration can disengage a lock of the touch surface 846; and a pressing of the button for a second duration that is longer than the first duration can turn power to the computing device 800 on or off. Pressing the button for a third duration can activate a voice control, or voice command, module that enables the user to speak commands into the microphone 830 to cause the device to execute the spoken command. The user can customize a functionality of one or more of the buttons. The touch surface 846 can, for example, also be used to implement virtual or soft buttons and/or a keyboard.

In some implementations, the computing device 800 can present recorded audio and/or video files, such as MP3, AAC, and MPEG files. In some implementations, the computing device 800 can include the functionality of an MP3 player, such as an iPod™ The computing device 800 can, therefore, include a 36-pin connector that is compatible with the iPod. Other input/output and control devices can also be used.

The memory interface 802 can be coupled to memory 850. The memory 850 can include high-speed random access memory and/or non-volatile memory, such as one or more magnetic disk storage devices, one or more optical storage devices, and/or flash memory (e.g., NAND, NOR). The memory 850 can store an operating system 852, such as Darwin, RTXC, LINUX, UNIX, OS X, WINDOWS, or an embedded operating system such as VxWorks.

The operating system 852 can include instructions for handling basic system services and for performing hardware dependent tasks. In some implementations, the operating system 852 can be a kernel (e.g., UNIX kernel). In some implementations, the operating system 852 can include instructions for performing voice authentication. For example, operating system 852 can implement the point of interest and/or area of interest presentation features as described with reference to FIGS. 1-7.

The memory 850 can also store communication instructions 854 to facilitate communicating with one or more additional devices, one or more computers and/or one or more servers. The memory 850 can include graphical user interface instructions 856 to facilitate graphic user interface processing; sensor processing instructions 858 to facilitate sensor-related processing and functions; phone instructions 860 to facilitate phone-related processes and functions; electronic messaging instructions 862 to facilitate electronic-messaging related processes and functions; web browsing instructions 864 to facilitate web browsing-related processes and functions; media processing instructions 866 to facilitate media processing-related processes and functions; GNSS/Navigation instructions 868 to facilitate GNSS and navigation-related processes and instructions; and/or camera instructions 870 to facilitate camera-related processes and functions.

The memory 850 can store other software instructions 872 to facilitate other processes and functions, such as the point of interest and/or area of interest presentation processes and functions as described with reference to FIGS. 1-7.

The memory 850 can also store other software instructions 874, such as web video instructions to facilitate web video-related processes and functions; and/or web shopping instructions to facilitate web shopping-related processes and functions. In some implementations, the media processing instructions 866 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. The memory 850 can include additional instructions or fewer instructions. Furthermore, various functions of the computing device 800 can be implemented in hardware and/or in software, including in one or more signal processing and/or application specific integrated circuits.

What is claimed is:

1. A method comprising:
receiving, by a computing device, search parameters for performing a point of interest search;
obtaining, by the computing device, search results based on the search parameters, the search results including a plurality of points of interest;
determining, by the computing device, that a first point of interest in the plurality of points of interest encompasses a geographical area;
identifying, by the computing device, one or more points of interest related to the first point of interest within a threshold distance of the geographical area; and
presenting the search results on a display of the computing device, where the related points of interest are presented grouped with the first point of interest in the search results.

2. The method of claim 1, wherein identifying one or more points of interest related to the first point of interest within a threshold distance of the geographical area includes identifying, by the computing device, one or more points of interest related to the first point of interest within a threshold distance of a perimeter of the geographical area.

3. The method of claim 1, further comprising:
selecting a number of related points of interest based on a popularity of the respective related points of interest; and
presenting the search results on a display of the computing device, where the selected number of points of interest are presented grouped with the first point of interest in the search results.

4. The method of claim 1, further comprising:
receiving user input selecting the first point of interest from the presented search results; and
presenting a map display that highlights a geographical area encompassed by the first point of interest and that presents representations of the related points of interest.

5. The method of claim 4, further comprising:
presenting one or more graphical elements each representing a point of interest category;
receiving user input selecting one of the graphical elements corresponding to a particular point of interest category;
filtering the related points of interest based on the particular point of interest category; and
presenting on the map display the related points of interest that correspond to the particular point of interest category.

6. The method of claim 5, further comprising:
presenting a placard identifying the particular point of interest category and identifying the related points of interest corresponding to the particular point of interest category.

7. The method of claim 4, wherein at least two of the related points of interest are grouped into a single representation on the map display.

8. A non-transitory computer readable medium including one or more sequences of instructions that, when executed by one or more processors, cause the processors to perform operations comprising:
receiving, by a computing device, search parameters for performing a point of interest search;
obtaining, by the computing device, search results based on the search parameters, the search results including a plurality of points of interest;
determining, by the computing device, that a first point of interest in the plurality of points of interest encompasses a geographical area;
identifying, by the computing device, one or more points of interest related to the first point of interest within a threshold distance of the geographical area; and
presenting the search results on a display of the computing device, where the related points of interest are presented grouped with the first point of interest in the search results.

9. The non-transitory computer readable medium of claim 8, wherein the instructions that cause identifying one or more points of interest related to the first point of interest within a threshold distance of the geographical area includes instructions that cause identifying, by the computing device, one or more points of interest related to the first point of interest within a threshold distance of a perimeter of the geographical area.

10. The non-transitory computer readable medium of claim 8, wherein the instructions cause:
selecting a number of related points of interest based on a popularity of the respective related points of interest; and
presenting the search results on a display of the computing device, where the selected number of points of interest are presented grouped with the first point of interest in the search results.

11. The non-transitory computer readable medium of claim 8, wherein the instructions cause:
receiving user input selecting the first point of interest from the presented search results; and
presenting a map display that highlights a geographical area encompassed by the first point of interest and that presents representations of the related points of interest.

12. The non-transitory computer readable medium of claim 11, wherein the instructions cause:
presenting one or more graphical elements each representing a point of interest category;
receiving user input selecting one of the graphical elements corresponding to a particular point of interest category;
filtering the related points of interest based on the particular point of interest category; and
presenting on the map display the related points of interest that correspond to the particular point of interest category.

13. The non-transitory computer readable medium of claim 12, wherein the instructions cause:
presenting a placard identifying the particular point of interest category and identifying the related points of interest corresponding to the particular point of interest category.

14. The non-transitory computer readable medium of claim 11, wherein at least two of the related points of interest are grouped into a single representation on the map display.

15. A system comprising:
one or more processors; and
a non-transitory computer readable medium including one or more sequences of instructions that, when executed by the one or more processors, cause the processors to perform operations comprising:
receiving, by a computing device, search parameters for performing a point of interest search;
obtaining, by the computing device, search results based on the search parameters, the search results including a plurality of points of interest;
determining, by the computing device, that a first point of interest in the plurality of points of interest encompasses a geographical area;
identifying, by the computing device, one or more points of interest related to the first point of interest within a threshold distance of the geographical area; and
presenting the search results on a display of the computing device, where the related points of interest are presented grouped with the first point of interest in the search results.

16. The system of claim 15, wherein the instructions that cause identifying one or more points of interest related to the first point of interest within a threshold distance of the geographical area includes instructions that cause identifying, by the computing device, one or more points of interest related to the first point of interest within a threshold distance of a perimeter of the geographical area.

17. The system of claim 15, wherein the instructions cause:
selecting a number of related points of interest based on a popularity of the respective related points of interest; and
presenting the search results on a display of the computing device, where the selected number of points of interest are presented grouped with the first point of interest in the search results.

18. The system of claim 15, wherein the instructions cause:
receiving user input selecting the first point of interest from the presented search results; and
presenting a map display that highlights a geographical area encompassed by the first point of interest and that presents representations of the related points of interest.

19. The system of claim 18, wherein the instructions cause:
presenting one or more graphical elements each representing a point of interest category;
receiving user input selecting one of the graphical elements corresponding to a particular point of interest category;
filtering the related points of interest based on the particular point of interest category; and
presenting on the map display the related points of interest that correspond to the particular point of interest category.

20. The system of claim 19, wherein the instructions cause:
presenting a placard identifying the particular point of interest category and identifying the related points of interest corresponding to the particular point of interest category.

21. The system of claim 18, wherein at least two of the related points of interest are grouped into a single representation on the map display.
